(19) United States
(12) Patent Application Publication
(10) Pub. No.: US 2007/0061236 A1
(43) Pub. Date: Mar. 15, 2007

(54) Combination of financial instruments and method for implementing investment strategy

(75) Inventors: Spyros N. Papadakis, New York, NY (US); Anthony J. Tuths, Short Hills, NJ (US)

Correspondence Address: Daniel H. Golub, 1701 Market Street, Philadelphia, PA, 19103, US

(73) Assignee: Lehman Brothers Inc., New York, NY (US)

(21) Appl. No.: 11/510,286

(22) Filed: Aug. 25, 2006

Related U.S. Application Data
(63) Continuation-in-part of application No. 10/831,934, filed on Apr. 26, 2004.
Application No. 10/831,934 is a continuation of application No. 10/763,826, filed on Jan. 23, 2004, now abandoned.
(60) Provisional application No. 60/442,035, filed on Jan. 23, 2003.

(51) Int. Cl. G06Q 40/00

(52) U.S. Cl. 705/36 R

(57) ABSTRACT

There is provided a method of marketing financial instruments. The method includes offering a discount certificate and a put certificate at the same time by a single issuer. The put certificate is tailored to the discount certificate so that when held at the same time, the certificates provide a particular return even if the discount certificate decreases in value.

This application is a continuation in part application of U.S. patent application Ser. No. 10/831,934, filed Apr. 26, 2004, which is a continuation application of U.S. patent application Ser. No. 10/763,826, filed Jan. 23, 2004, which claims priority to U.S. Provisional Patent Application No. 60/442,035, filed Jan. 23, 2003, all of which are incorporated herein by reference in their entirety.

### BACKGROUND OF THE INVENTION

1. Field of the Invention

The present invention relates to methods for implementing an investment strategy and, more particularly, issuing financial securities including a discount certificate and a put certificate that, when held at the same time, provide an investor with an equity-linked market return and downside protection.

2. Description of the Related Art

An original issue discount (OID) debt instrument is a debt instrument that is issued at a discount to its maturity value. That is, the issue price of the OID debt instrument is less than its maturity value.

Typically, an OID debt instrument does not pay interest per se. In such a case, the issuer of the OID debt instrument does not make interest payments and, thus, an investor in the OID debt instrument does not receive any payment until maturity. The value of the OID debt instrument is derived from the difference between its present market value and its maturity value (which the issuer is obligated to pay at maturity). However, although the investor does not actually receive any interest, United States Treasury Regulations (OID regulations) require the investor to accrue the discount and recognize the accrued discount as income under the OID regulations. Conversely, for non-debt financial instruments in which the issuer is not obligated to pay a fixed amount at maturity (and thus the investor risks loss of principal), the OID regulations would not apply.

An OID debt instrument may also take the form of a contingent payment debt instrument (“CPDI”) in which the amount of the payment at maturity is a minimum fixed amount plus an amount contingent on the occurrence or non-occurrence of a particular event or some other reference. The contingent amount of an OID debt instrument may vary inversely with a variation in market rates such that, as market rates trend upwards, the contingent amount of the OID debt instrument decreases. Alternatively, an OID debt instrument, such as a principal protected equity-linked debt instrument, may provide a return that varies directly with the value of certain market rates or indices such that, as the value of such rates or indices rise, the contingent amount of the OID debt instrument increases.

There is a need for an investment strategy in which an investor is protected against a loss of principal but not subject to the OID regulations.

### SUMMARY OF THE INVENTION

One embodiment of the present invention is a method of marketing financial instruments and implementing an investment strategy. The method includes offering a discount certificate and a put certificate. The put certificate and the discount certificate are issued by a single issuer. The put certificate is tailored to the discount certificate so that holding the certificates at the same time provides a minimum return even if the discount certificate decreases in value.

Another embodiment of the present invention is a combination of separate financial instruments. This entails an investor holding a discount certificate and a put certificate issued by a single issuer. The put certificate is tailored to the discount certificate so that holding the certificates at the same time provides a minimum return even if the discount certificate decreases in value.

### BRIEF DESCRIPTION OF THE DRAWINGS

The accompanying drawings, wherein like referenced numerals are employed to designate like parts or steps, are included to provide a further understanding of the invention, are incorporated and constitute a part of this specification, and illustrate embodiments of the invention that together with the description serve to explain the principles of the invention.

In the drawings:

FIG. 1 illustrates a discount certificate profit/loss profile.

FIG. 2 illustrates a put certificate profit/loss profile.

FIG. 3 illustrates a profit/loss profile of the financial instrument issued and held in accordance with the investment strategy of the present invention.

FIGS. 4A and 4B illustrate how the discount certificate and the put, issued and held in accordance with the present invention, would perform in a rising then falling market.

FIG. 5 illustrates how the discount certificate and the put, issued and held in accordance with the present invention, would perform in a rising market.

FIG. 6 illustrates how the discount certificate and the put, issued and held in accordance with the present invention, would perform in a falling market.

FIG. 7 illustrates an exemplary implementation of the inventive investment strategy.

FIG. 8 is a flow chart illustrating a preferred embodiment method of the present invention.

FIG. 9 is a diagram illustrating an alternate preferred embodiment of the present invention.

### DESCRIPTION OF THE INVENTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention relates to implementing an investment strategy pursuant to which a put certificate and a discount certificate, offered by different issuers and tradeable, are held at the same time by an investor. The inventive offering provides investors with upside potential linked to the performance of the S&P 500 Index, also referred to herein as the “Index”, in the preferred embodiment, with downside protection at maturity when the separate components of the offering are held together. The put certificate includes terms that are tailored to the discount certificate such that, when the certificates are held at the same time, the investor will receive a certain return even if the discount certificate suffers a loss of value. Thus, when held at the same time, the put certificate hedges risk associated with the discount certificate. Holding both certificates at the same time provides performance similar to that of a principal-protected, equity-linked note.

A financial instrument is a contract between parties that provides a payment by one party based on some objective information. A debt instrument is a financial instrument that entitles a holder of the debt instrument to all, or a substantial portion of, an original investment; thus, it entitles its holder to no less than a fixed amount of money at a fixed date. In the present invention, both the discount certificate and the put certificate are issued as separate financial instruments, but not as debt instruments. Because the investor holds two separate non-debt instruments, the instruments are not subject to the OID taxation and the ordinary income/loss treatment applicable to traditional principal-protected equity-linked notes.

In the preferred embodiment, the discount certificate and the put certificate (also referred to herein as the “put”) are each offered pursuant to a private placement, or in registered form, with an expected term of five to five and one-half years. The final term is determined upon the date of issuance in the preferred embodiment; for purposes of illustrating the invention herein, a five year term is used. The discount certificate and the put can each be purchased separately in the private placement, or in registered form, should trade independently in the secondary market, and will have different CUSIP numbers, in the preferred embodiment.

In accordance with the present invention, investors who hold the discount certificate and the put will have full exposure to the upside appreciation of, for example, the monthly average Index return (where the average Index return is the percentage increase of the average monthly Index level over its initial trade date level.) Using an average index return to measure performance has the effect of reducing the volatility of the Index and, hence, improving equity participation. In addition, investors who hold both the discount certificate and the put until maturity are entitled to receive at least 100% of their invested capital, regardless of the performance of the Index. Both the discount certificate and the put are issued by separate entities and, in the preferred embodiment, the entities are related. Investors who hold both the discount certificate and the put, in accordance with the present invention, will achieve economics similar to a traditional principal-protected, equity-linked note but, unlike a traditional equity-linked note, are subject to taxation only on disposition. The discount certificate and the put are each subject to separate tax treatment and, therefore, are taxed as capital assets, providing investors with benefits such as tax deferral and, possibly, lower effective tax rates.

The discount certificate and the put that comprise the inventive offering may be offered in one private placement, a registered offering, individually or together. In the preferred embodiment, and for purposes of illustration herein, the total offering price of both the discount certificate and the put is $1,000 per unit. After the initial offering, holders can trade the discount certificate and the put in the secondary market at different times or together at the same time.

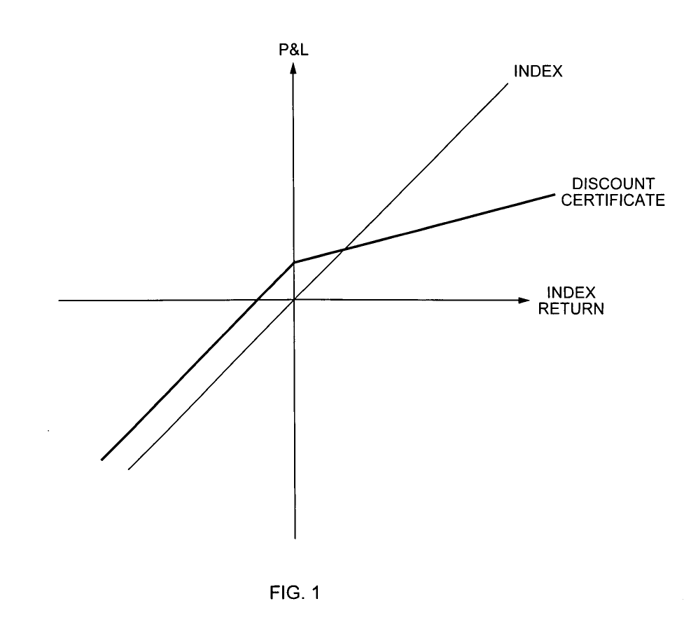

The discount certificate will now be described in more detail with reference to FIG. 1, which illustrates the discount certificate profit/loss profile. The bold line marked “Discount Certificate” represents the payoff to the investor. The discount certificate is an obligation of Company A. The discount certificate provides upside opportunity if the Index appreciates on average over the investment term. However, the holder of the discount certificate is exposed to downside risk if the Index depreciates. Upon disposition, the discount certificate is subject to capital gain/loss tax treatment.

More particularly, the discount certificate offers upside opportunity based on the monthly average performance of the Index while retaining the full downside risks of the Index. The discount certificate is a privately placed, or registered, five-year (in the exemplary embodiment), security issued by Company A. It is issued in principal amounts of $1,000 per certificate. In the illustrated embodiment, the issue price is $810 per $1,000 certificate, or 81% of the Principal Amount. The discount certificate offers an equity-linked return based upon the arithmetic average of the closing levels of the Index on sixty monthly dates over five years. The percentage increase of the average monthly index level over the initial index level is called the Average Index Return. If the Average Index Return is positive, investors will receive, at maturity, 100% of the Average Index Return, i.e., investors will receive an additional $10 per certificate, or 1% of par, for each 1% of Average Index Return, in addition to the par amount. If the Average Index Return is zero or less, investors will receive no upside return above par. The discount certificate provides no principal protection and has the same downside risk as the Index. The percentage increase of the final index level at maturity over the initial index level is called the Final Index Return. If the Final Index Return is negative, the investors' payoff from each Discount Certificate will be reduced by $10, or 1% of par, for each 1% of index depreciation from the Trade Date to maturity. If the Final Index Return is zero or above, investors will have no downside loss.

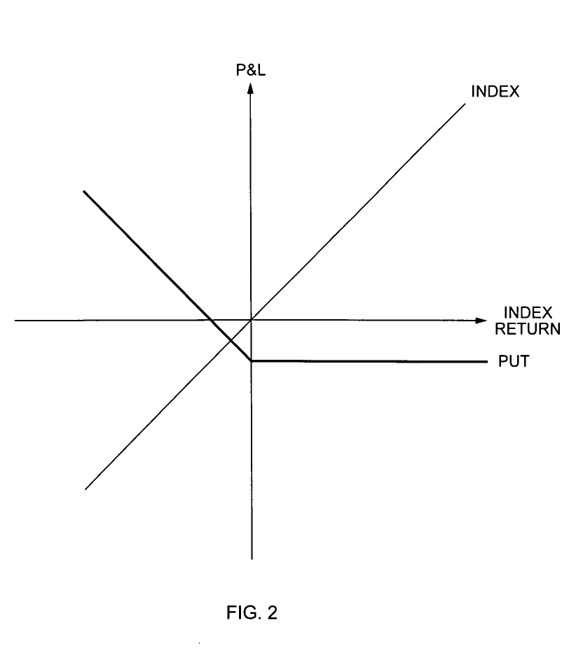

The put will now be described in more detail with reference to FIG. 2, which illustrates the put certificate profit/loss profile. The bold line marked “Put” represents the payoff to the investor. The put is an obligation of Company A1. The put requires the investor to pay a premium up front. If the Index appreciates, the holder of the put will receive zero payoff. If the Index depreciates, the holder of the put will receive a positive payoff. Like the discount certificate, the put is subject to capital gain/loss tax treatment on disposition.

More particularly, the put offers a positive payoff if the Index depreciates and is, therefore, capable of entirely offsetting the downside risks of the discount certificate. The put is a privately placed, or registered, five-year (in the illustrated embodiment) security issued by Company A1. The put will be cash-settled at maturity. It is issued at a price equal to $1,000 minus the initial price of the discount certificate, or approximately $190 per put, 19% of principal amount, in the illustrated embodiment. If the Final Index Return is negative, (i.e., if the Index has depreciated), investors will receive 1% of the Principal Amount, or $10, for every percent of depreciation in the Index. If the Final Index Return is zero or above, (i.e., if the Index has not depreciated), the payoff will be zero.

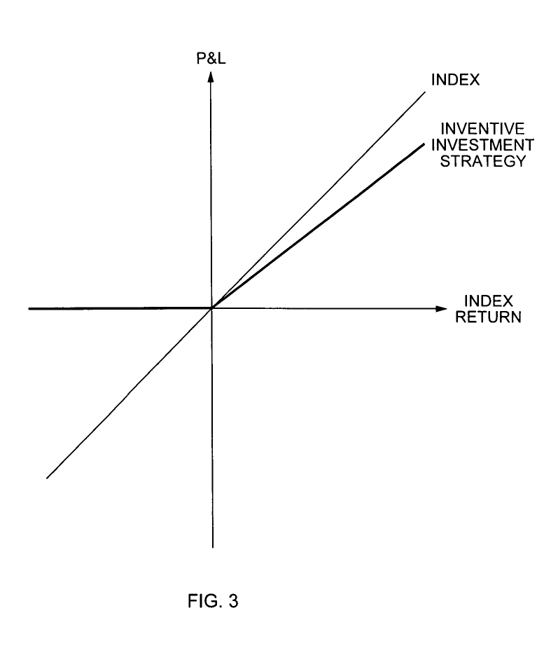

The inventive investment strategy is illustrated with reference to FIG. 3, which shows the profit/loss profile of the financial instruments issued in accordance with the present invention. The bold line marked “Inventive Investment Strategy” represents the payoff to the investor. The discount certificate and the put are sold in a single private placement, or registered offering, initially offered at par ($1,000 per unit), in the preferred embodiment. Each component may be sold or bought separately. This strategy provides upside opportunity if the Index appreciates on average over the investment term. If the put is held to maturity, the investor's entire principal is protected. The instruments are not subject to OID taxation and receive capital gain/loss tax treatment on disposition.

The following examples illustrate the how the discount certificate and the put, issued in accordance with the present invention, would perform in different markets, namely, a rising then falling market, a rising market, and a falling market.

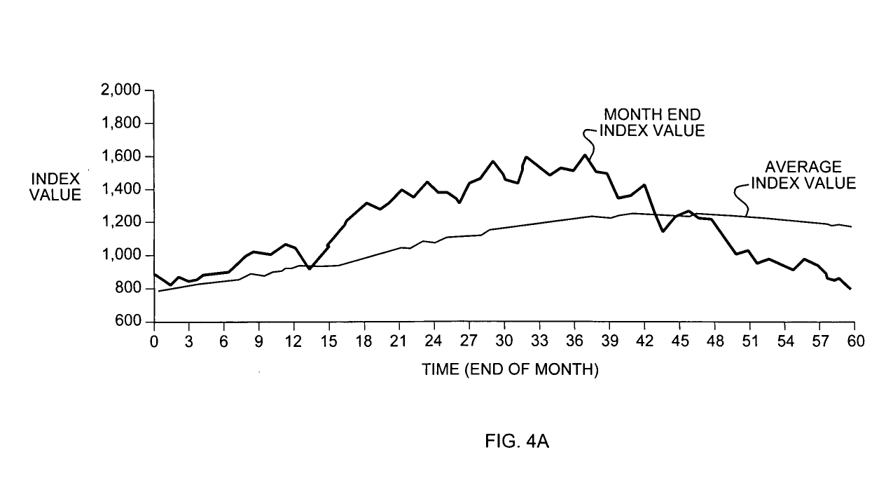

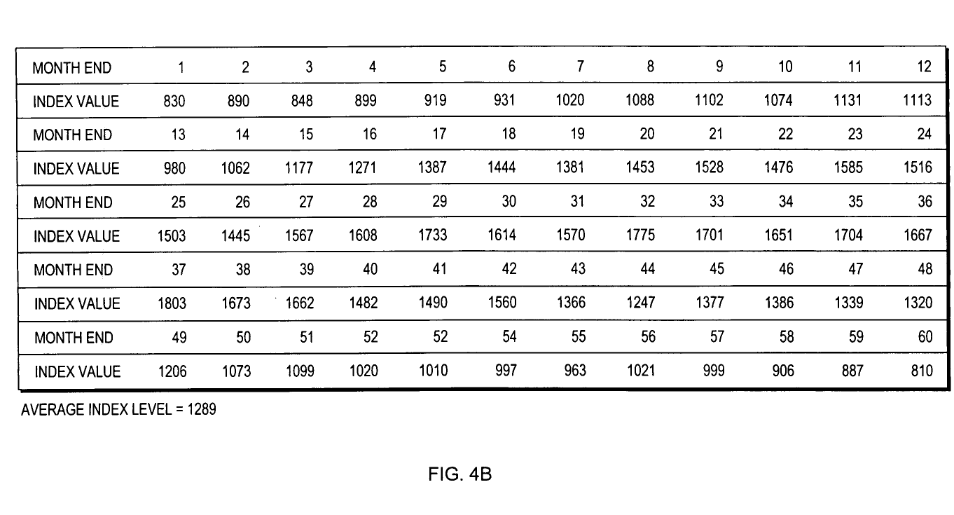

With reference to FIGS. 4A and 4B, in an example illustrating a rising then falling market, the following assumptions apply: both the discount certificate and the put have a maturity of 5 years; the Initial Index Level is 900, the Final Index Level is 810 and, therefore, the Final Index Return is 10% (810/900−1); the Average Index Level over 5 years, as calculated in the table shown in FIG. 4B, is 1289 (i.e., the sum of the monthly closing index levels divided by 60), and therefore the Average Index Return is 43.2% (1289/900−1).

Because the Average Index Return in the illustrated example is positive, the investor will receive $1,000×43.2%, or $432, per certificate in addition to par. Since the Final Index Return is negative and the Index has depreciated by 10%, the investor's payoff will be reduced by $1,000×10%, or $100. Therefore, the payoff of the Discount Certificate equals $1,000+$432−$100, or $1,332. Because the Final Index Return is negative and the Index has depreciated by 10%, the put payoff will be $1,000×10%, or $100, offsetting the downside loss in the discount certificate. The investor's total payoff for both securities, issued in accordance with the present invention, will be the sum of the above, or $1,432. In this example, the investor will receive a positive return on the combination, despite a negative Final Index Return, as a result of (1) principal protection provided by the put; and (2) the Average Index Return over 5 years benefiting from the high Index values in the first half of the investment term and remaining positive despite the Index depreciation during the second half.

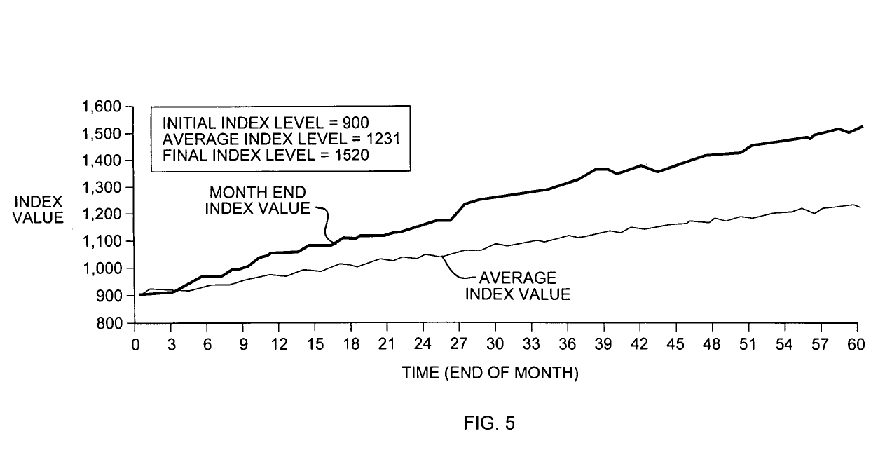

In an example illustrating a rising market, it is assumed that the Index appreciates gradually, as shown in the chart of FIG. 5. The Final Index Level is 1520, therefore the Final Index Return is 68.9% (1520/900−1). The Average Index Level over 5 years is 1231 (the sum of the monthly closing index levels divided by 60), and therefore the Average Index Return is 36.8% (1231/900−1).

Because the Average Index Return is positive, the investor will receive $1,000×36.8%, or $368, per certificate in addition to par. Because the Final Index Return is also positive, the investor will have no downside loss. Therefore, the payoff of the discount certificate equals $1,000+$368, or $1,368. The put payoff will be zero, given that Final Index Return is positive. The investor's total payoff for both securities, issued in accordance with the present invention, will be the sum of the above, or $1,368. In this example, the positive Average Index Return leads to a positive return for the financial instruments issued in accordance with the invention, which is, however, lower than the Final Index Return.

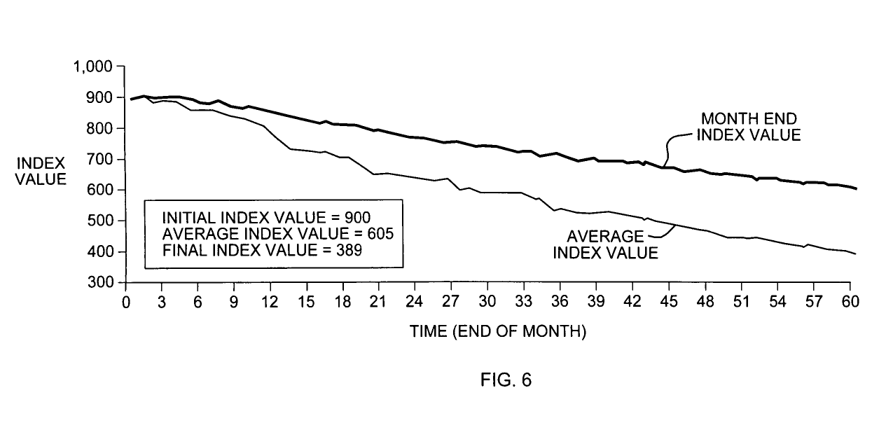

In an example illustrating a rising market, it is assumed-that the Index depreciates gradually as shown in the chart of FIG. 6. The Final Index Level is 389, therefore, the Final Index Return is 56.8% (389/900−1). The Average Index Level over 5 years is 605 (the sum of the monthly closing index levels divided by 60), and therefore the Average Index Return is 32.8% (605/900−1). Because the Average Index Return is negative, the investor will receive no additional upside return above par. Because the Final Index Return is negative and the Index has depreciated by 56.8%, the investor's payoff will be reduced by $1,000×56.8%, or $568. Therefore, the payoff of the discount certificate equals $1,000−$568, or $432. Because the Final Index Return is negative and the Index has depreciated by 56.8%, the put payoff will be $1,000×56.8%, or $568. The investor's total payoff for both securities, issued in accordance with the present invention, will be the sum of the above, or $1,000. In this example, although the Average Index Return and the Final Index Return are both negative, holding both securities in accordance with the present invention returns the investor's principal investment at maturity.

The discount certificate and the put that are issued and held in accordance with the present invention offer similar economic features as those of holding a single traditional equity-linked note, such as downside protection and equity-linked upside potential when held together. However, while the tax treatment of a traditional equity-linked note often makes such investments less attractive to a U.S. investors, the inventive investment strategy is designed to be more tax efficient. In particular, under current U.S. tax rules, traditional principal protected equity-linked notes are generally treated as contingent payment debt instruments. As a result, holders are required to pay taxes on phantom income based on the issuer's comparable debt yield on an annual basis, even though no actual income may have been received. In addition, gains and losses on the disposition of the notes are generally treated as ordinary income/loss.

The beneficial tax treatment of the discount certificate and the put issued and held in accordance with the present invention results from the structure being comprised of two separate instruments, a cash settled forward contract (the discount certificate) and a put option, that are separately tradable and are issued by separate companies. Neither instrument is treated as a debt instrument for United States federal income tax purposes. As a result, the discount certificate and the put are subject to separate tax treatment, and will be subject to taxation only at maturity or when sold. Both the discount certificate and the put are capital assets, and gains and losses recognized on each should be treated as capital gains or losses.

Straddle rules apply while investors hold both the discount certificate and the put in accordance with the present invention. As such, the tax treatment of the inventive investment would result in short-term capital gains treatment for any gains upon disposition or termination while both instruments are held together. If, however, an investor holds only one of the two components, the straddle rules will not apply for such period, as long as the investor does not have other offsetting positions with respect to the Index (or a substantially similar investment).

Investors may sell either the discount certificate or the put at any time prior to maturity. By selling the put, an investor can achieve long-term capital gains treatment on their discount certificate investment by holding the instrument for over 1 year after the sale of the put, so long as the investor does not have or enter into other offsetting positions with regard to the Index. This type of transaction makes sense for investors where, over the investment term, the Index has performed well, the put is far out-of-the money, and the investor considers it unlikely that the Index will fall below the initial level in the remaining term. Furthermore, any loss on the disposition of the put would be treated as a capital loss (deferred until any unrealized gains in offsetting positions are recognized), and any gains in the discount certificate will be long-term if held for more than one year after the sale of the put and the investor does not have other offsetting positions during that time with respect to the Index.

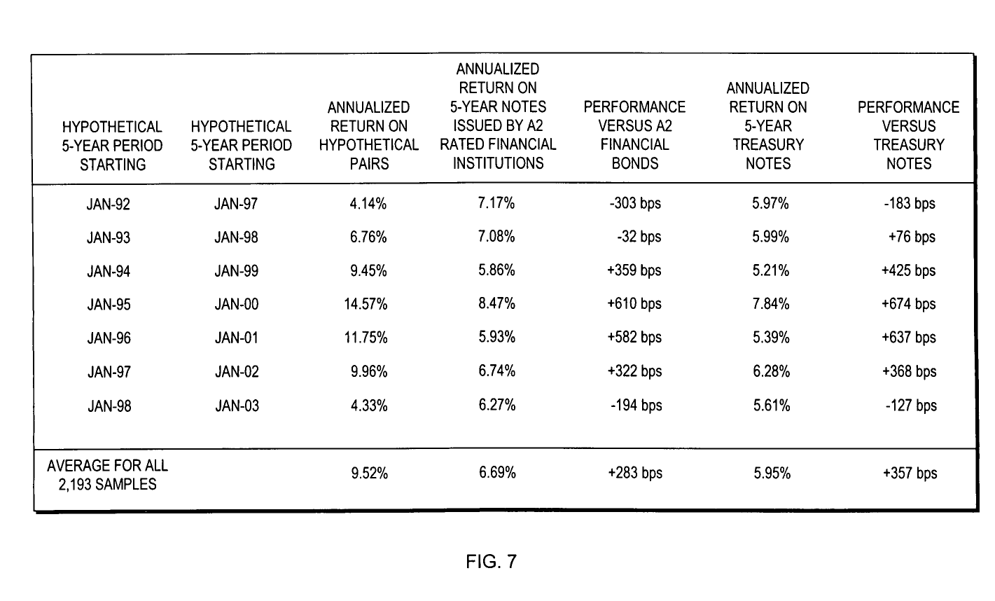

With reference to FIG. 7, an example implementing the inventive investment strategy is provided. This example involves a single five-year, traditional equity-linked note with the same before-tax economics as the discount certificate and the put held in accordance with the present invention. This examples assumes the issuer's comparable debt yield is 4% per annum and, at maturity, both the equity linked note and inventive investment receive a payoff of 130% of par (a 30% gain).

With the equity-linked note issue, investors are subject to contingent payment debt treatment, and therefore are required to pay taxes on phantom income—a projected rate based on the issuer's 4% debt yield every tax year. The investor's cost basis will be adjusted up accordingly to reflect the taxes paid. At maturity, the 130% payoff will be compared against the increased cost basis and the excess will be taxed as ordinary income.

In comparison, for securities held in accordance with the present invention, investors are not required to pay taxes until the discount certificate and the put mature or when they are sold in the secondary market. At maturity, the 30% gain will be taxed as short term capital gains. Long term capital gain treatment can be achieved if the investor becomes comfortable holding the discount certificate without explicit principal protection and thus sells the put no later than one year and one day prior to maturity (provided the investor does not have other offsetting positions with respect to the Index).

The results of the test conducted to illustrate how the financial instruments issued and held in accordance with the present invention perform are shown in FIG. 7. In particular, the performances of approximately 2,000 hypothetical issues during the 11-year period between January 1992 and January 2003 were tested. There were 2,193 samples in total, assuming the inventive investments had been issued on a daily basis from January 1992 to January 1998 and matured from January 1997 to January 2003. The test assumed that both the discount certificate and the put were held for the entire investment term. The table in FIG. 7 shows a pre-tax summary of the backtest results. As shown in FIG. 7, the average performance of the inventive investment yielded an average pre-tax annualized return of 9.52%, or a compounded return of 57.6% after 5 years without principal risk.

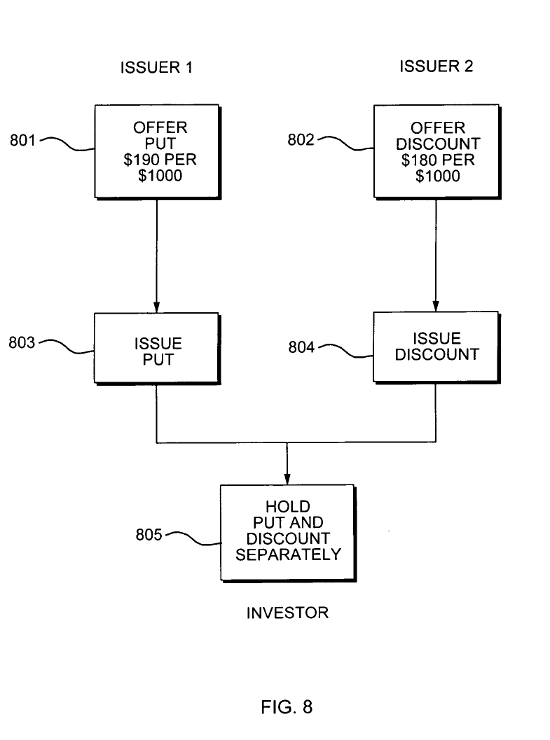

A preferred embodiment of a method of the present invention is illustrated in FIG. 8. In step 801, a put certificate is offered to an investor by a first issuer. In step 802, a discount certificate is offered to an investor by a second issuer. An issue price of the put certificate is tailored to an issue price of the discount certificate. In this example, the issue price of the discount certificate is $810 per $1,000 certificate and the issue price of the put certificate is $190 per put. The issue price of the put certificate and the issue price of the discount certificate comprise a principal investment (in this example, $1,000). In step 803, the first issuer issues to the investor the put certificate. In step 804, the second issuer issues to the investor the discount certificate. In step 805, the investor-holds the put certificate and the discount certificate simultaneously and separately such that the investor receives an equity-linked market return and preserves the principal investment.

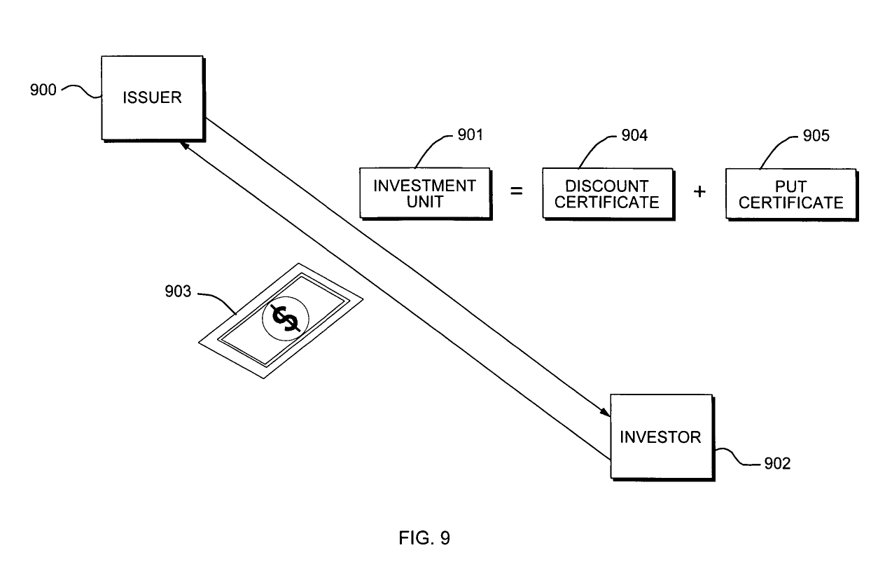

In another preferred embodiment of the present invention, a single issuer issues the put certificate and the discount certificate. This embodiment is illustrated with reference to FIG. 9. A single issuer 900 issues an investment unit 901 to investor 902, in exchange for an investment payment 903. The investment unit 901 comprises (1) a discount certificate 904 entitling investor 902 to a certain percentage of participation in the specified index and (2) a put certificate 905 entitling the investor 902 to 100% of the index value as of the date of the purchase of the investment unit 901. The discount certificate 904 and the put certificate 905 may be separated by the Investor at any time and both components are tradable independent of each other. As in the other embodiments described herein, the investor 902 holds the put certificate 905 and the discount certificate 904 simultaneously and separately.

Maintaining the investment unit 901 as two distinct financial instruments is important for reasons related to taxation of the investor. If the investment unit 901 were not respected as two distinct financial instruments (i.e., the discount certificate 904 and the put certificate 905) but was, instead, collapsed into a single instrument, the economics would dictate that it be treated as a CPDI. The laws relating to CPDIs force investors to accrue income on a current basis and pay tax on phantom income (i.e., investors are taxed each year they hold the instrument even though they receive no cash until maturity and the amount of such cash at maturity may be any amount, including zero). Additionally, all income in respect of a CPDI is treated as ordinary income, as opposed to capital gain, and taxed at the highest marginal rates. Respecting the two financial instruments delays any taxation until maturity and permits any gain to be treated as capital gain instead of ordinary income.

The United States Treasury issued Revenue Ruling 2003-97 on Jul. 23, 2003. In accordance with this Revenue Ruling, separate tax treatment was afforded to two financial products (a note and an equity forward contract) issued by a single issuer to the same investor simultaneously. In this Ruling, the maturity dates of the two instruments were separated by two years. However, it is believed that the separate tax treatment would be accorded even if the two financial instruments were coterminous.

The present invention is intended to embrace all alternatives, modifications and variances that fall within the scope of the appended claims.

What is claimed is:

1. A method of marketing financial instruments, comprising:
offering a discount certificate and a put certificate at the same time,
wherein said put certificate and said discount certificate are issued by a single issuer, and said put certificate is tailored to said discount certificate so that when held at the same time, said certificates provide a particular return even if said discount certificate decreases in value.

2. A combination of financial instruments, comprising:
a discount certificate and a put certificate,
wherein said put certificate and said discount certificate are issued by a single issuer, and said put certificate is tailored to said discount certificate so that when held at the same time, said certificates provide a particular return even if said discount certificate decreases in value.
